(19) United States
(12) Patent Application Publication
(10) Pub. No.: US 2019/0244227 A1
(43) Pub. Date: Aug. 8, 2019

(54) BULLETIN BOARD INFORMATION MANAGEMENT SYSTEM

(71) Applicant: NEC Corporation, Tokyo (JP)

(72) Inventor: Tetsuo INOUE, Tokyo (JP)

(73) Assignee: NEC Corporation, Tokyo (JP)

(21) Appl. No.: 16/319,842

(22) PCT Filed: Jun. 28, 2017
(86) PCT No.: PCT/JP2017/023796

§ 371 Date: Jan. 23, 2019

(30) Foreign Application Priority Data
Jul. 28, 2016 (JP) 2016-148246

(51) Int. Cl. G06Q 30/02; H04L 29/06; H04L 29/08

(52) U.S. Cl. CPC G06Q 30/0201; H04L 63/0428; H04L 67/1093; H04L 63/123

(57) ABSTRACT

A node device configuring a peer-to-peer network includes a network interface and a blockchain management part. The blockchain management part receives, through the network interface, a first information registration request transaction that includes first information including a keyword on a product and bulletin board information representing an opinion of a customer on the product, an electronic signature signed on the first information with a private key of the customer, and a public key paired with the private key. The blockchain management part accumulates the first information registration request transaction into a blockchain based on a consensus building algorithm executed in cooperation with another node device configuring the peer-to-peer network.

### TECHNICAL FIELD

The present invention relates to a bulletin board information management system, a node device, a bulletin board information management method, a terminal device, and a program.

### BACKGROUND ART

For manufacturers, distributors and the like of products (hereinafter referred to as manufacturers), customer's opinions on products are important information. For this reason, manufacturers collect customers' opinions on products by various methods.

For example, a server device which enables exchange of opinions and the like on products on a network between a consumer and a company or between consumers has been proposed as a first related art that is related to the present invention (For example, Patent Document 1). More specifically, in the first related art, the server device is connected to a product providing company's terminal and a consumer's terminal via the network. The server device stores a plurality of product information in association with corresponding product identification information into a storage part so as to be able to transmit the product information to the consumer's terminal, and has a chat unit which allows input from the consumer's terminal and the product providing company's terminal. Chat information of the chat unit is stored in association with the product identification information into the storage part.

Patent Document 1: Japanese Unexamined Patent Application Publication No. JP-A 2004-157633

Non-Patent Document 1: Satoshi Nakamoto, “Bitcoin A Peer-to-Peer Electronic Cash System” [online], [searched on Jun. 17, 2016], the Internet<URL: https://bitcoin.org/bitcoin.pdf>

Non-Patent Document 2: Chin Cheng Liang, “A Next-Generation Smart Contract and Decentralized Application Platform” [online], [searched on Jun. 17, 2016], the Internet<URL: https://github.com/ethereum/wiki/wiki/White-Paper>

However, in the first related art, a company which provides products to consumers operates a single server device. For this reason, there is a problem that the single server device becomes a bottleneck and capabilities such as reliability, availability and maintainability decrease.

### SUMMARY

An object of the present invention is to provide a bulletin board information management system that solves the above-described problem.

A bulletin board information management system as an aspect of the present invention includes a peer-to-peer network configured by a plurality of node devices capable of peer-to-peer communication with each other and a terminal device. The terminal device includes a first network interface and an information registration request transaction generation part. The information registration request transaction generation part is configured to generate a first information registration request transaction and broadcast to the peer-to-peer network through the first network interface. The information registration request transaction generation part is configured to generate the first information registration request transaction based on first information including a keyword on a product and bulletin board information representing an opinion of a customer on the product, an electronic signature signed on the first information with a private key of the customer, and a public key paired with the private key. Each of the node devices includes a second network interface and a blockchain management part. The blockchain management part is configured to accumulate the first information registration request transaction received through the second network interface into a blockchain based on a consensus building algorithm executed in cooperation with another node device.

A node device as another aspect of the present invention is a node device configuring a peer-to-peer network, and the node device includes a network interface and a blockchain management part. The blockchain management part is configured to: receive, through the network interface, a first information registration request transaction that includes first information including a keyword on a product and bulletin board information representing an opinion of a customer on the product, an electronic signature signed on the first information with a private key of the customer, and a public key paired with the private key; and accumulate the first information registration request transaction into a blockchain based on a consensus building algorithm executed in cooperation with another node device configuring the peer-to-peer network.

A bulletin board information management method as another aspect of the present invention is a bulletin board information management method executed by a node device including a network interface and a blockchain management part and configuring a peer-to-peer network. The blockchain management part is configured to: receive, through the network interface, a first information registration request transaction that includes first information including a keyword on a product and bulletin board information representing an opinion of a customer on the product, an electronic signature signed on the first information with a private key of the customer, and a public key paired with the private key; and accumulate the first information registration request transaction into a blockchain based on a consensus building algorithm executed in cooperation with another node device configuring the peer-to-peer network.

A computer program as another aspect of the present invention includes instructions for causing a computer configuring a peer-to-peer network to function as: a network interface; and a blockchain management part configured to: receive, through the network interface, a first information registration request transaction that includes first information including a keyword on a product and bulletin board information representing an opinion of a customer on the product, an electronic signature signed on the first information with a private key of the customer, and a public key paired with the private key; and accumulate the first information registration request transaction into a blockchain based on a consensus building algorithm executed in cooperation with another node device configuring the peer-to-peer network.

A terminal device as another aspect of the present invention is a terminal device broadcasting an information registration request transaction to a peer-to-peer network configured by a plurality of node devices capable of peer-to-peer communication with each other. The terminal device includes: a network interface and an information registration request transaction generation part. The information registration request transaction generation part is configured to generate the information registration request transaction and broadcast to the peer-to-peer network through the network interface. The information registration request transaction generation part is configured to: generate the information registration request transaction based on first information including a keyword on a product and bulletin board information representing an opinion of a customer on the product, an electronic signature signed on the first information with a private key of the customer, and a public key paired with the private key.

With the configurations described above, the present invention can provide a bulletin board information management system which is excellent in capabilities such as reliability, availability and maintainability.

### BRIEF DESCRIPTION OF DRAWINGS

FIG. 1 is a diagram showing an example of the configuration of a first example embodiment of the present invention;

FIG. 2 is a flowchart showing an example of a bulletin board information registration procedure in the first example embodiment of the present invention;

FIG. 3 is a flowchart showing an example of a bulletin board information use procedure (reference procedure) in the first example embodiment of the present invention;

FIG. 4 is a configuration diagram of a second example embodiment;

FIG. 5 is an information component diagram showing the relation between information retained by an information registrant device and the content of an information registration request transaction;

FIG. 6 is a diagram showing an example of the configuration of an information registration request transaction including a program code;

FIG. 7 is a signal sequence diagram how an information registration request transaction is broadcast from the information registrant device to a peer-to-peer network that manages a bulletin board information DB;

FIG. 8 is a flowchart how an information registration request transaction signal is sent to the peer-to-peer network that manages the bulletin board information DB in the information registrant device;

FIG. 9 is an information component diagram showing the relation between a plurality of transactions and the contents of a plurality of blocks in a blockchain;

FIG. 10 is a flowchart showing an example of processing by a node which participates in the peer-to-peer network;

FIG. 11 is a diagram showing an example of judgment whether public keys of a plurality of information registration request transactions corresponding to an identical product keyword match or not;

FIG. 12 is a flowchart showing another example of processing by a node which participates in the peer-to-peer network; and

FIG. 13 is a configuration diagram of a third example embodiment.

### EXAMPLE EMBODIMENTS

Next, an example embodiment of the present invention will be described in detail with reference to the drawings.

### First Example Embodiment

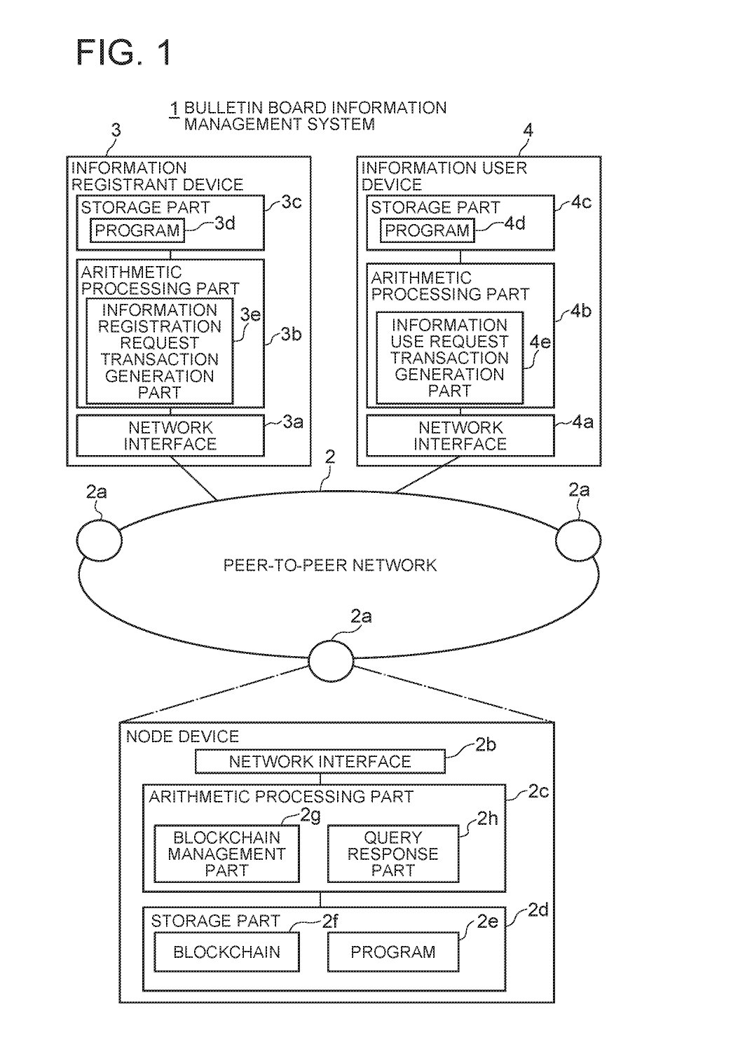

With reference to FIG. 1, a bulletin board information management system 1 according to a first example embodiment of the present invention includes a peer-to-peer network 2, an information registrant device 3, and an information user device 4.

The information registrant device 3 is a device used by a person who registers bulletin board information, and one or more devices are included. Herein, bulletin board information contains, for example, document data in text format expressing a customer's opinion on a product in a natural language. The information registrant device 3 includes a network interface 3a, an arithmetic processing part 3b, and a storage part 3c.

The network interface 3a is composed of a dedicated data communication circuit, and has a function to perform data communication with the peer-to-peer network and the like connected via a wired or wireless communication line.

The storage part 3c is composed of a storage device such as a hard disk and a memory, and has a function to store processing information and a program 3d that are necessary for various processing by the arithmetic processing part 3b. The program 3d is a program loaded and executed by the arithmetic processing part 3b to realize various processing parts. The program 3d is previously loaded from an external device (not shown in the drawings) or a program storage medium (not shown in the drawings) via a data input/output function such as the network interface 3a and stored into the storage part 3c.

The arithmetic processing part 3b has a microprocessor such as a CPU and a peripheral circuit thereof, and has a function to load and execute the program 3d from the storage part 3c to make the above-described hardware and the program 3d cooperate and realize various processing parts. A major processing part realized by the arithmetic processing part 3b is an information registration request transaction generation part 3e.

The information registration request transaction generation part 3e has a function to generate an information registration request transaction and broadcast the transaction to the peer-to-peer network 2 through the network interface 3a. Based on first information including a keyword on a product and bulletin board information representing an opinion by a customer on the product, an electronic signature signed by using a private key of the customer to the first information, and a public key paired with the private key, the information registration request transaction generation part 3e generates a first information registration request transaction. A keyword on a product includes the name of a product (trademark or the like), the generic name of a product, or the like.

The information user device 4 is a device used by a person who uses (refers to) bulletin board information, and one or more devices are included. The information user device 4 includes a network interface 4a, an arithmetic processing part 4b, and a storage part 4c.

The network interface 4a is composed of a dedicated data communication circuit, and has a function to perform data communication with the peer-to-peer network 2 and the like connected via a wired or wireless communication line.

The storage part 4c is composed of a storage device such as a hard disk and a memory, and has a function to store processing information and a program 4d that are necessary for various processing by the arithmetic processing part 4b. The program 4d is a program loaded and executed by the arithmetic processing part 4b to realize various processing parts. The program 4d is previously loaded from an external device (not shown in the drawings) or a program storage medium (not shown in the drawings) via a data input/output function such as the network interface 4a and stored into the storage part 4c.

The arithmetic processing part 4b has a microprocessor such as a CPU and a peripheral circuit thereof, and has a function to load and execute the program 4d from the storage part 4c to make the above-described hardware and the program 4d cooperate and realize various processing parts. A major processing part realized by the arithmetic processing part 4b is an information use request transaction generation part 4e.

The information use request transaction generation part 4e has a function to generate an information use request transaction for querying bulletin board information corresponding to a product keyword and broadcast the transaction to the peer-to-peer network 2 through the network interface 4a. The information use request transaction generation part 4e also has a function to receive a response to the query by the information use request transaction through the network interface 4a.

The peer-to-peer network 2 is composed of a plurality of node devices 2a capable of peer-to-peer communication with each other. Each of the node devices 2a includes a network interface 2b, an arithmetic processing part 2c, and a storage part 2d.

The network interface 2a is composed of a dedicated data communication circuit, and has a function to perform data communication with various devices such as the other node device 2a, the information registrant device 3 and the information user device 4 connected via a wired or wireless communication line.

The storage part 2d is composed of a storage device such as a hard disk and a memory, and has a function to store processing information and a program 2e that are necessary for various processing by the arithmetic processing part 2c. The program 2e is a program loaded and executed by the arithmetic processing part 2c to realize various processing parts. The program 2e is previously loaded from an external device (not shown in the drawings) or a program storage medium (not shown in the drawings) via a data input/output function such as the network interface 2b and stored into the storage part 2d. Major processing information stored in the storage part 2d is a blockchain 2f.

The blockchain 2f is a data structure in which blocks each grouping transactions over a certain period are connected in a chain. For example, the blockchain 2f may be a blockchain of Ethereum, but is not limited to it. The blockchain 2f is also referred to as a bulletin board information DB.

The arithmetic processing part 2c has a microprocessor such as a CPU and a peripheral circuit thereof, and has a function to load and execute the program 2e from the storage part 2d to make the above-described hardware and the program 2e cooperate and realize various processing parts. Major processing parts realized by the arithmetic processing part 2c are a blockchain management part 2g and a query response part 2h.

The blockchain management part 2g has a function to accumulate information registration request transactions received through the network interface 2b into the blockchain 2f, based on a consensus building algorithm executed in cooperation with the other node 2a. A consensus building algorithm refers to a general algorithm for mutually recognizing a distributed ledger by using Proof of Work (PoW) or the like. PoW corresponds to an operation called “mining” in bitcoin and Ethereum.

The query response part 2h has a function to, upon receiving an information query request through the network interface 2b, acquire bulletin board information corresponding to a product keyword contained in the information query request, from the information accumulated in the blockchain 2f, and generate a response for sending through the network interface 2b.

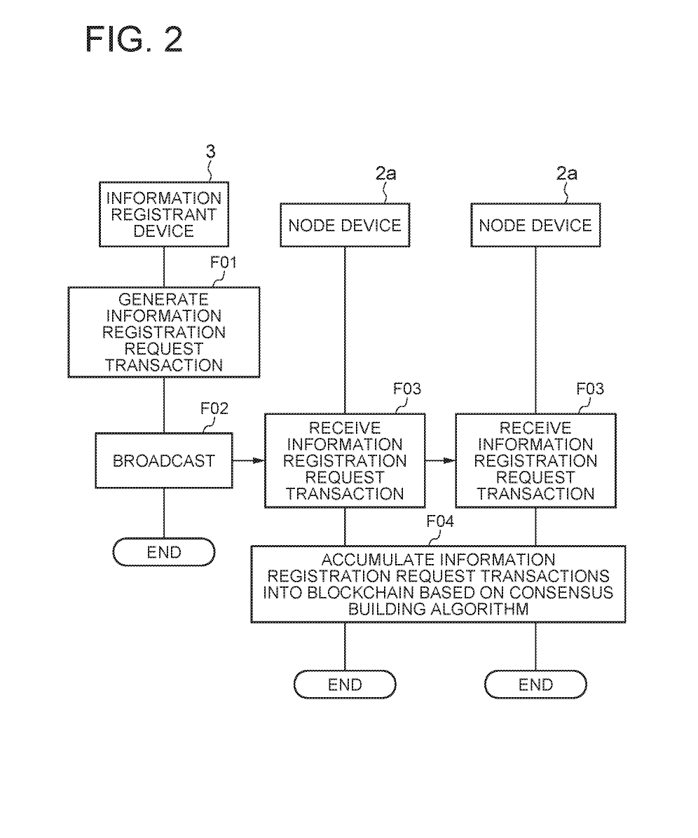

FIG. 2 is a flowchart showing an example of a bulletin board information registration procedure. With reference to FIG. 2, the information registrant device 3 generates an information registration request transaction by the information registration request transaction generation part 3e (F01). An information registration request transaction includes first information including a keyword on a product and bulletin board information representing an opinion of a customer on the product, an electronic signature signed by using a private key of the customer to the first information, and a public key paired with the private key. Next, the information registration device 3 broadcasts the information registration request transaction to the peer-to-peer network 2 through the network interface 3a (F02).

Each of the node devices 2a receives the information registration request transaction broadcast to the peer-to-peer network 2, by the network interface 2b (F03). Next, each of the node devices 2a accumulates the received information registration request transactions into the blockchain 2f, by the blockchain management part 2g, based on a consensus building algorithm executed in cooperation with the other node device 2a (F04).

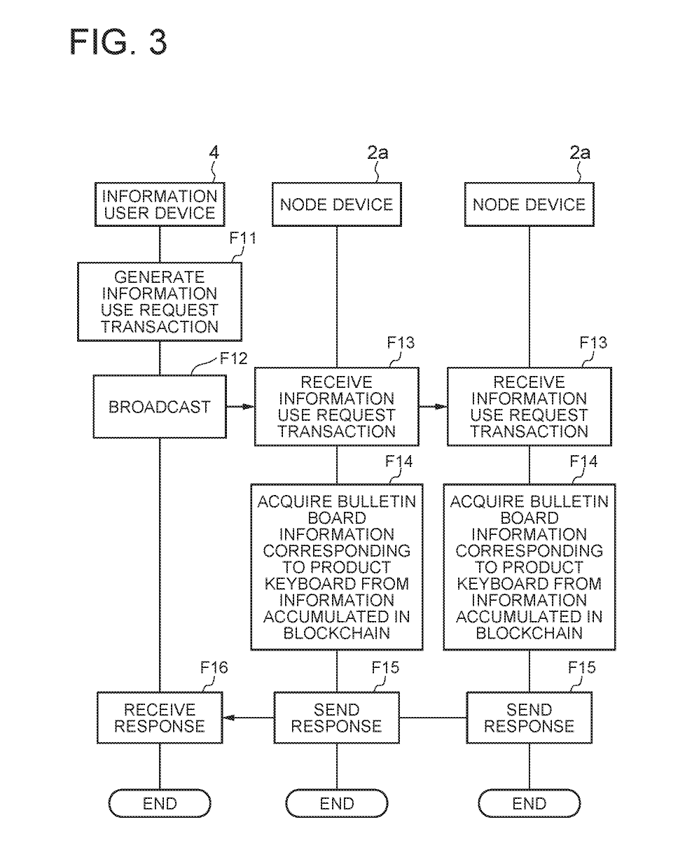

FIG. 3 is flowchart showing an example of a bulletin board information use procedure (reference procedure). With reference to FIG. 3, the information user device 4 generates an information use request transaction to query bulletin board information corresponding to a product keyword by the information use request transaction generation part 4e (F11). Next, the information user device 4 broadcasts the information use request transaction to the peer-to-peer network 2 by the network interface 4a (F12).

Each of the node devices 2a receives the information use request transaction broadcast to the peer-to-peer network 2, by the network interface 2b (F13). Next, each of the node devices 2a acquires bulletin board information corresponding to a product keyword included in an information query request from the information accumulated in the blockchain 2f, by the query response part 2h (F14). Next, each of the node devices 2a sends a response including the acquired information to the information user device 4, by the network interface 2b (F15).

The information user device 4 receives the response from the node device 2a by the network interface 4a (F16). In the case of receiving responses from a plurality of node devices 2a with respect to the information use request transaction having been sent, the information user device 4 adopts a response from any of the node devices 2a. For example, the information user device 4 may adopt, as a response node, the node device 2a having presented earliest the bulletin board information selected by majority vote or the like. Alternatively, the information user device 4 may specify its original rule such as adopting information at a time when the minimum required number of nodes that return the same bulletin board information is reached. A rule to pay some fee to an adoption node or a node that provides adoption information.

Thus, according to this example embodiment, bulletin board information is managed by using the blockchain technology, so that it is possible to provide a bulletin board information management system that is excellent in reliability, availability, and maintainability.

In this example embodiment, various additions and modifications can be made based on the above configuration and operation.

For example, the blockchain management part 2g may be configured to: receive a second information registration request transaction that includes second information including a list of keywords on products, a program code and a manufacturer's certificate, electronic signature signed by using a manufacture's private key to the second information, and a public key paired with the manufacture's private key, from the information registrant device 3 through the network interface 2b; and accumulate the second information registration request transactions into the blockchain 2f based on a consensus building algorithm.

Further, the program code may be configured to, when executed by a computer configuring the blockchain management part 2g, in a case where a keyword on a product included in the first information registration request transaction stored in the blockchain 2f is written in the keyword list, cause the computer to send bulletin board information included in the first information registration request transaction to a terminal device corresponding to the manufacturer.

Further, the program code may be configured to further cause the computer to send information urging a process of verifying the validity of the bulletin board information to the terminal device corresponding to the manufacturer.

Further, the blockchain management part 2g may be configured to: receive a third information registration request transaction that includes third information including the result of verification of the validity of bulletin board information and the certificate of the manufacturer, an electronic signature signed by using the private key of the manufacturer to the third information, and a public key paired with the private key of the manufacturer, from the information registrant device 3 through the network interface 2b; and accumulate the third information registration request transactions into the blockchain 2f based on a consensus building algorithm.

Further, the program code may be configured to be automatically executed when a first information registration request transaction is stored into the blockchain 2f.

Further, the blockchain management part 2g may be configured to: search the blockchain 2f for another first information registration request transaction including the same keyword as a keyword on a product included in a first information registration request transaction having been received; and based on the result of comparison between a public key included in the searched other first information registration request transaction and a public key included in the received first information registration request transaction, determine the validity of the received first information registration request transaction.

Further, the blockchain management part 2g may be configured to, when a public key included in the received first information registration request transaction matches public keys included in all the other retrieved first information registration request transactions, the received first information registration request transaction is valid.

### Second Example Embodiment

Next, a second example embodiment of the present invention will be described.

### Problem to Be Solved by This Example Embodiment

Examples of efforts to install a shared bulletin board from the viewpoint of product information tracing include a user group portal, devotee's SNS, twitter™ and the like related to a product. In particular, the latter two of the three no longer require the initial operators' attention. However, information provided on such bulletin boards is not necessarily accurate and largely depends on the subjectivity of information senders.

Since an information sender is anonymous, the administrator of an information bulletin board is necessary to exclude posting of malicious information. The administrator needs to keep supervising bulletin board information.

In this example embodiment, as a method for managing bulletin board information, managing bulletin board information with the use of a common distributed DB and eliminating malicious information even when the administrator is absent will be described.

In other words, according to the conventional art, judgement whether bulletin board information is good or bad by an anonymous person needs to keep a bulletin board administrator to continue supervising the bulletin board and eliminate malicious information (task 1).

Further, according to such a mechanism, it is required to increase processing capability, reliability, availability and so on of the DB due to information enlargement such as bulletin board is required (issue 2).

### Configuration of This Example Embodiment

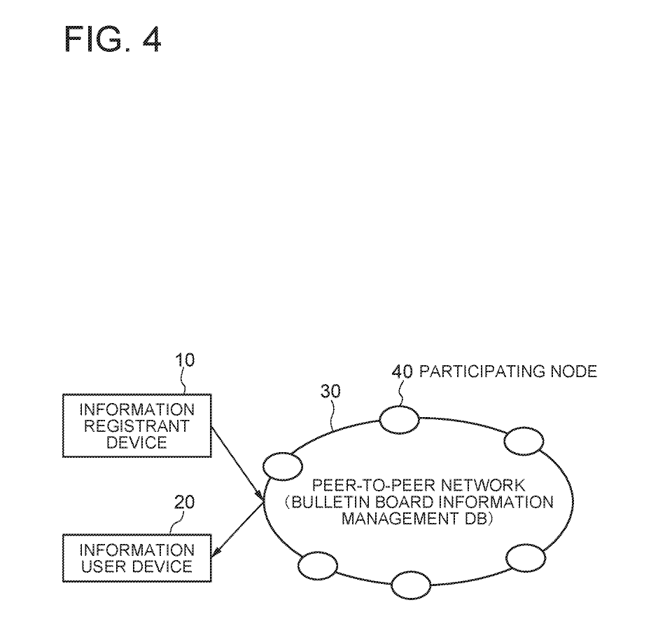

With reference to FIG. 4, this example embodiment includes information registrant devices 10 for registering information to a bulletin board information management DB, user devices 20 for a user of information in the bulletin board information management DB, and a peer-to-peer network 30 that manages a blockchain (a chain of cryptologic hash blocks) dealt in bitcoin (Non-Patent Document 1), which is one of virtual currencies, and in Ethereum (Non-Patent Document 2), which is one of smart contract realization platforms using the distributed ledger technology.

The bulletin board information management DB and the DB manager apparatus in this example embodiment are retained and managed by a plurality of nodes 40 participating in the peer-to-peer network 30. The plurality of nodes 40 participating in the peer-to-peer network 30 may belong to a product manufacturing company or a product distribution company or a community of a plurality of companies, or may be an anonymous individual or anonymous organization not belonging to any organization.

The plurality of nodes 40 participating in the peer-to-peer network 30 take a role of not only retaining information and responding to queries but also evaluating the validity of requested registration information with a program which is in the information retained in the DB and can be automatically executed.

### Operation of This Example Embodiment

The information registrant device 10 registering information to the bulletin board information management DB in this example embodiment broadcasts a transaction requesting information registration to the bulletin board information management DB to the entire peer-to-peer network 30 and makes a request for information registration.

Each of the nodes 40 participating in the peer-to-peer network 30 validates the information registration request transaction having been broadcast and, if judging valid, the node 40 generates a new block grouped as a block together with another valid information registration request transaction, and adds the new block to the end of the blockchain. A reward to the participating node 40 is paid at the time of validation of the information registration request transaction and creation of the new block.

According to Non-Patent Documents 1 and 2, a blockchain is recorded in a form that blocks with hash values calculated are connected in a chain and consensus on the validity of the content is built among all the nodes 40 participating the peer-to-peer network 30. Therefore, it is generally said that the content recorded as a blockchain cannot be altered actually. Moreover, it is generally said that even if a certain node 40 intentionally records wrong information or intends not to record a requested content, all the participating nodes try to record a correct content while building a consensus, and therefore, the content recorded as a blockchain is accurate.

The user device 20 using information in the bulletin board information management DB in this example embodiment queries the peer-to-peer network 30 about helpful information retained in the bulletin board information management DB. Alternatively, any of the nodes 40 participating in the peer-to-peer network 30 autonomously transfers information to the appropriate user device 20 in accordance with an executable program code already registered as information associated with a keyword on a product among information retained in the bulletin board information management DB. Information to be autonomously transferred includes, for example, information urging processing that the manufacturer of a product related to the bulletin board information verifies the validity of newly posted information.

Below, the configuration and operation of this example embodiment will be described in more detail.

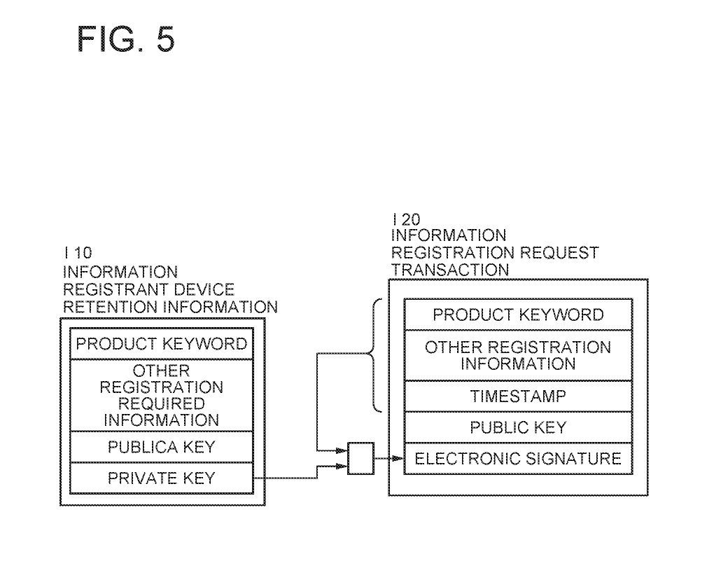

FIG. 5 shows an example of the configuration of an information registration request transaction. An information registration request transaction I20 in this example includes a product keyword, other registration required information, a timestamp, an information registrant's public key, and an electronic signature. A product keyword is a keyword on a product and includes the name of a product (trademark or the like), the generic name of a product, and the like. Other registration required information includes bulletin board information. Bulletin board information includes, for example, text-format document data expressing a customer's opinion on a product in a natural language.

An electronic signature is a signature with an information registrant's private key on information including a product keyword, other registration required information and a timestamp. An information registrant's private key and public key pair, a product keyword, and other registration required information are stored in a memory or the like of the information registrant device 10, and retrieved from the memory or the like and used at the time of generation of the information registration request transaction I20.

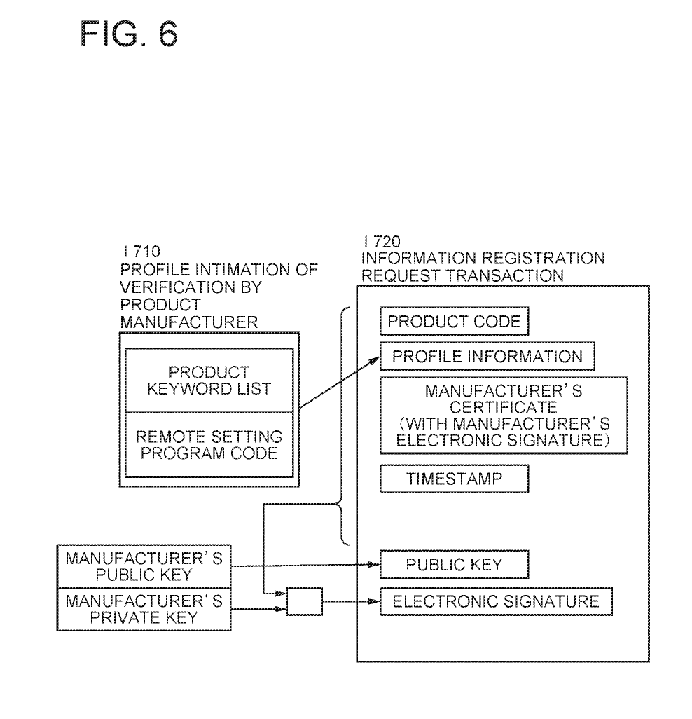

FIG. 6 shows another example of the configuration of an information registration request transaction. An information registration request transaction I720 of this example includes a product code, profile information, a manufacturer's certificate (with an electronic signature by the manufacturer), a timestamp, a manufacturer's public key, and an electronic signature. A product code is a number which uniquely identifies a product. The details of profile information include, as shown by profile information I710 for verification by a product manufacturer shown in FIG. 6, a product keyword list and a remote setting program code.

The product keyword list in the profile information I710 includes one or more keywords on a product. The remote setting program code in the profile information I710 is a program code for causing a computer configuring the node 40 (equivalent to the arithmetic processing part 2c in FIG. 1) to execute. For example, the program code is configured to, when executed by the computer configuring the node 40, cause the node 40 to send at least the other registration required information in the information registration request transaction I20 to a terminal device corresponding to the manufacturer (for example, the information registrant device 10 or the information user device 20 corresponding to the manufacturer) in a case where a product keyword included in the information registration request transaction I20 stored in the blockchain is written in the product keyword list. Moreover, the program code is configured to, when executed by the computer of the node 40, cause the node 40 to send information urging the process to verify the validity of bulletin board information included in the other registration required information in the information registration request transaction I20, to a terminal device corresponding to the manufacturer.

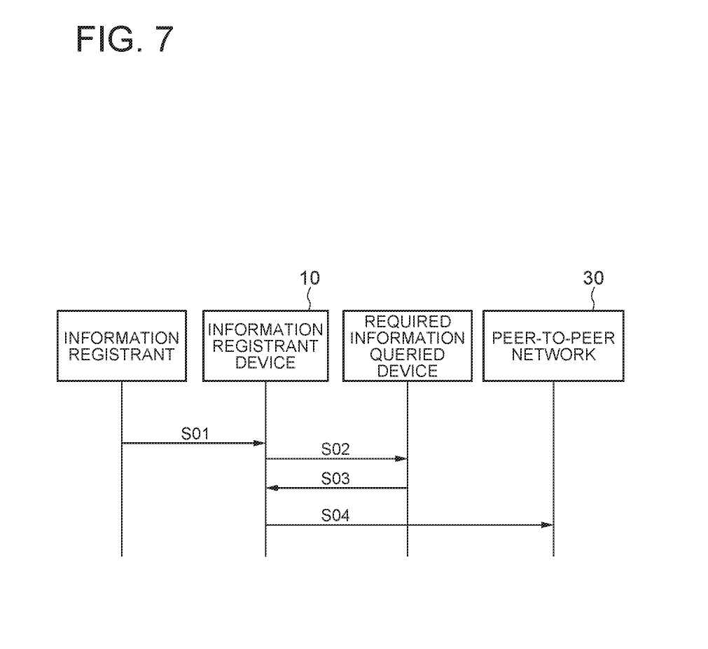

FIG. 7 is a signal sequence diagram how the information registration request transaction I20 is broadcast from the information registrant device 10 to the peer-to-peer network 30 managing the bulletin board information DB. FIG. 7 shows that an information registrant inputs a private key and public key pair, a product keyword and other registration required information into the information registrant device 10, and the information registrant device 10 acquires predetermined information from a required information query destination device and thereafter broadcasts the information registration request transaction I20 including these information provided with a timestamp and signed with the private key to the peer-to-peer network 30. Herein, the required information query destination device is, for example, a product's manufacturer, a distributer's server device, and the like.

In FIG. 7, a signal S01 shows an information input signal from an information registrant to the information registrant device 10. The signal S01 includes a private key and a public key of the information registrant, a product keyword, bulletin board information, identification information of the information registrant, the URL of a required information queried device, and so on. A signal S02 is a predetermined information acquisition request signal from the information registrant device 10 to the required information queried device, and a signal S03 is a response signal thereto. The signal S02 includes the customer identification number of the information registrant, the URL of a required information queried device, and so on. The signal S03 includes access information to a manufacturer and a manufacturer. The access information may include information such as a contract ID that can be known only by the information registrant, the manufacturer and a seller know. A signal S04 denotes an information registration request transaction signal to be broadcast from the information registrant device 10 to the peer-to-peer network 30. The signal S04 includes a product keyword, other registration required information (including the access information acquired in the signal S04), a timestamp, an electronic signature calculated by using the information and a private key, and a public key.

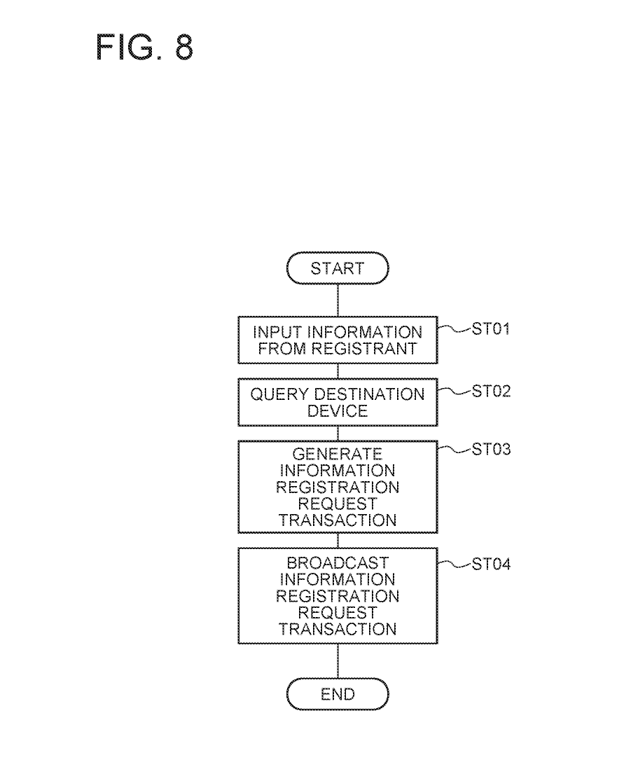

FIG. 8 is a flowchart how an information registration request transaction signal is sent to the peer-to-peer network 30 that manages the bulletin board information DB in the information registrant device 10. Step ST01 is a step in which the information registrant device 10 inputs information from an information registrant, and a private key, a public key, a product keyword, other registration required information and so on are input. Step ST02 is a step in which the information registrant device 10 queries the required information queried device about access information, and a contract ID or the like is obtained from a customer identification number. Step ST03 is a step in which the information registrant device 10 generates an information registration request transaction, and a product keyword, other registration required information (including the contract ID obtained in step ST02), a timestamp, an electronic signature obtained by encrypting the hash values with a private key, and a public key are included. Step ST04 is a step of broadcasting the information registration request transaction generated by the information registrant apparatus 10 to the peer-to-peer network 30.

The signal sequence and processing flow how the information registration request transaction I720 is broadcast from the information registrant device 10 to the peer-to-peer network 30 is basically the same in the case of the information registration request transaction described with reference to FIGS. 7 and 8. However, in the case of the information registration request transaction I720, a manufacture's public key and private key pair, a product code, profile information, manufacture identification number and so on are input from the information registrant to the information registrant terminal 10. Moreover, the information registrant device 10 acquires a manufacture's certificate (with a manufacture's electronic signature) from a necessary information queried device.

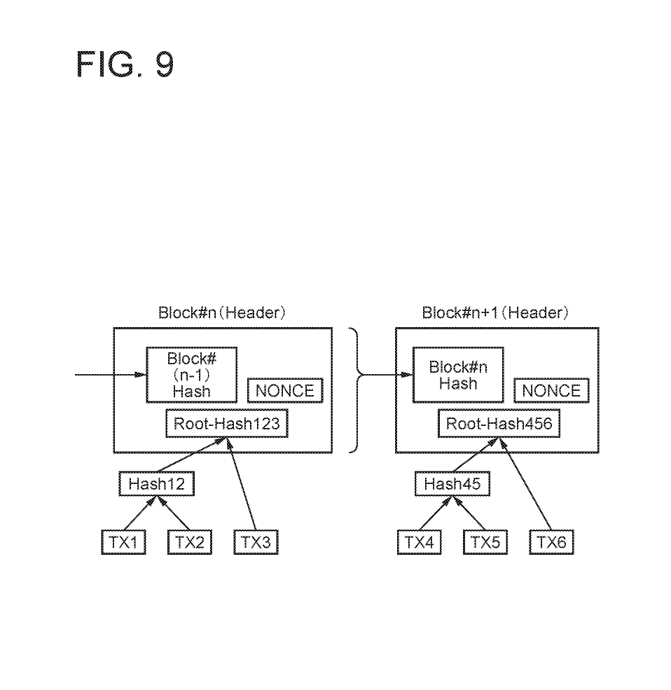

FIG. 9 is an information component diagram showing a relation between a plurality of transactions and the contents of a plurality of blocks in a blockchain. Each TX denotes an information registration request transaction. Each Hash denotes a hash value calculated by a cryptographic hash function of two transactions. Hash calculation is performed on all the transactions in one block generation period and, until one Root-Hash value (also referred to as Merkle-Root value) is finally obtained, each participating node 40 repeats validation of the transaction and calculation of the hash value. When a block generation time comes, each participating node 40 calculates a hash value of a new block by using hash values of blocks having been broadcast at a previous block generation time (or hash values of all blocks recalculated by the participating node itself and of the previous block) and a Root-Hash value generated from an information registration request transaction newly occurred during a current block generation period. At the time, a hash value of a new block is obtained while regulating a NONCE value or the like so that the hash value of the new block becomes a value based on a rule in a consensus building process of peer-to-peer network regulations, and the result is broadcast to the peer-to-peer network 30.

Because computer power by enormous cryptographic hash calculation, transaction validation, blockchain generation and so on is provided by the participating nodes 40 of the peer-to-peer network 30, motivation for maintaining the network is necessary. That is, some commission is required.

According to Non-Patent Document 1, certain bitcoins are given to a person who has succeeded in winning the competition of hash calculation of a new block that is a bundle of transactions for trading (transfer of the owner of) bitcoins, which is cryptocurrency, and recording at the end of the blockchain. This is called coin mining. At present, new blocks are generated at intervals of about 10 minutes and 25 bitcoins are mined. The amount of mined coins every 10 minutes halves once every four years. Mined coins do not affect the issuer of a transaction. In addition to coin mining, a separate fee from the issuer of a transaction may also be included in the transaction (transfer of the owner of bitcoins for the fee). It is also possible to define different cryptocurrencies and multipurpose points on the bitcoin base.

According to Non-Patent Document 2, certain ethers are given to a person (hereinafter referred to as a mining successor) who has succeeded in winning the competition of hash calculation of a new block that is a bundle of transactions concerning not only trading (transfer of the owner) of ether, which is cryptocurrency in Ethereum, but also conclusion of a smart contract (a contract that can be confirmed by a computer) and contract performance (a code that can be automatically executed by a computer), and recording at the end of the blockchain. A reward given to a mining successor includes 5 ethers fixed for one mine and ethers corresponding to the amount of transaction information collected from a transaction issuer and fuel (Gas) of Ethereum regulations necessary for executing a contract performance code.

In this example embodiment, an information registration request transaction approval fee for recording to a blockchain of a bulletin board information management DB is paid in the same way as the virtual currencies or by separately determined cryptocurrency, multipurpose point, or the like.

The above consensus building process is carried out by competition of cryptographic hash calculation at the time of blockchain update or by a consensus building rule exclusive for peer-to-peer network defined separately.

Distribution of the approval fee to the participating nodes of the peer-to-peer network is done by a winner having won the competition of cryptographic hash calculation or by a separately defined consensus building rule.

The information registrant apparatus 10 does not concern the consensus building process, the rule or the approval fee distribution method and can simply confirm success or failure of a transaction issued by the information registrant apparatus 10 by a registration information confirmation method as the information user apparatus 20, but the confirmation is not required in particular. That is, at the time of broadcasting an information registration request transaction, confirmation is unnecessary if it is believed that the transaction has succeeded by the consensus building process of the peer-to-peer network, but any confirmation is possible unless it is not believed immediately.

A blockchain is obtained by cryptographic hash calculation of a plurality of transactions issued in the past and a plurality of blocks generated in the past, and all the nodes 40 participating in the peer-to-peer network 30 retain the same information by the consensus building process, so that tampering such as alteration and deletion is practically impossible. When a certain node 40 intends to tamper with past data, the node needs to perform again hash calculation of a transaction which the node wants to tamper with, a block retaining the transaction and all transactions occurring thereafter and hash calculation of all blocks generated thereafter, and keep winning the competition of cryptographic hash computation or showing as if there is no contradiction in the consensus building process to all of the other participating nodes 40. Therefore, the success or failure of the tampering is determined based on the superiority or inferiority of computer power of the node that wants to tamper and the total of computer power of all of the other participating nodes. As block generation progresses, a probability that the malicious node keeps winning drops dramatically, so that the blockchain having been tampered with will be eventually found and replaced with another valid blockchain. This shows that a blockchain cannot be tampered with actually.

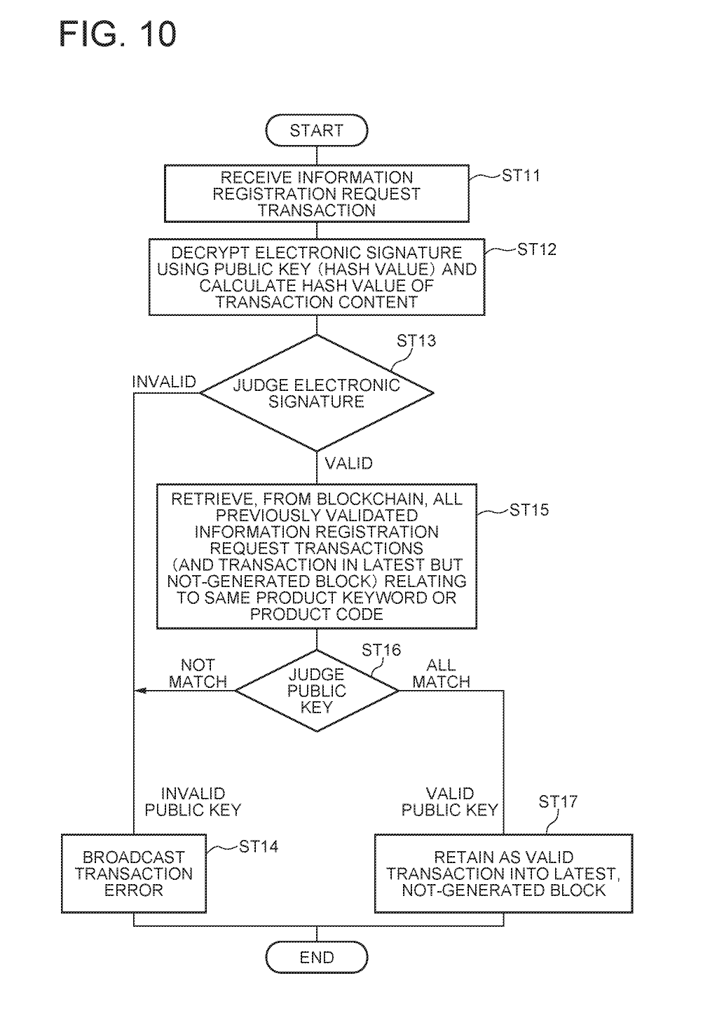

FIG. 10 is a flowchart showing an example of processing by the node 40 participating in the peer-to-peer network 30. The processing shown in FIG. 10 is executed in a computer (equivalent to the arithmetic processing part 2c of the node device 2a of FIG. 1) configuring the node 40.

With reference to FIG. 10, upon receiving an information registration request transaction broadcast from the information registrant device 10 (ST11), the node 40 decrypts an electronic signature included in the received information registration request transaction by using a public key included in the received information registration request transaction, and also calculates a hash value from the content of the received information registration request transaction (in the case shown in FIG. 5, a product keyword, other registration required information, and a timestamp; in the case shown in FIG. 6, a product code, profile information, a manufacturer certificate, and a timestamp) (ST12). Next, the node 40 judges the validity of the electronic signature by comparing a hash value obtained by decrypting the electronic signature with the generated hash value (ST13). Next, if the electronic signature is invalid, the node 40 regards the currently received information registration request transaction as an invalid transaction and broadcasts a transaction error to the pee-to-peer network (ST14).

On the other hand, if the electronic signature is valid, the node 40 retrieves, from the blockchain, all the previously validated information registration request transactions (and an information registration request transaction in the latest, not-generated block) relating to the same product keyword or product code as the product keyword or product code included in the currently received information registration request transaction (ST15). Next, based on the public key included in the currently received information registration request transaction and the public keys included in the information registration request transactions retrieved at step ST15, the node 40 judges whether all the public keys match, that is, only one public key is present, or whether the public keys do not match, that is, a public key which does not match the other public keys is present (ST16). If all the public keys match, the node 40 regards the currently received information registration request transaction as a valid transaction and retains the transaction into the latest, not-generated block (ST17). On the other hand, if the public keys do not match, the node 40 regards the currently received information registration request transaction as an invalid transaction and broadcasts a transaction error to the peer-to-peer network (ST14).

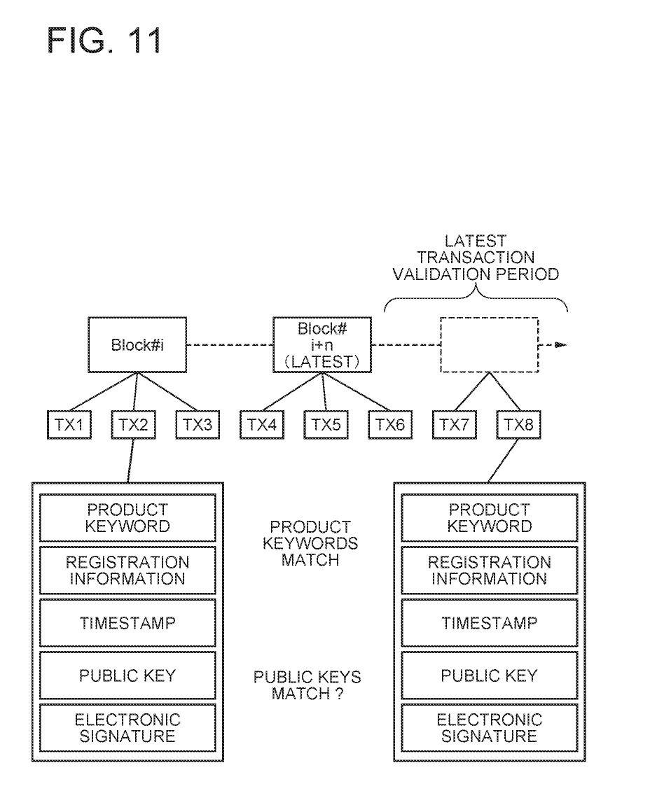

FIG. 11 is a conceptual diagram showing an example of the processes at steps ST15 and ST16 of FIG. 10. In FIG. 11, TX8 denotes a currently received information registration request transaction, and TX1 to TX7 denote previously validated information registration request transactions (and an information registration request transaction in the latest, not-generated block). Moreover, the information registration request transaction TX2 is a transaction including the same product keyword (or product code) as the product keyword (or product code) included in the information registration request transaction TX8. The node 40 compares the public key of the information registration request transaction TX2 with the public key of the information registration request transaction TX8 and, if the public keys match, regards the currently received information registration request transaction TX8 as a valid transaction.

Adopting the configuration as described with reference to FIGS. 10 and 11 makes it possible to obtain a bulletin board information management system which is robust against an attack such that a malicious third party who knows a product keyword or product code used by someone else generates any private key and public key pair and broadcasts a fake information registration request transaction.

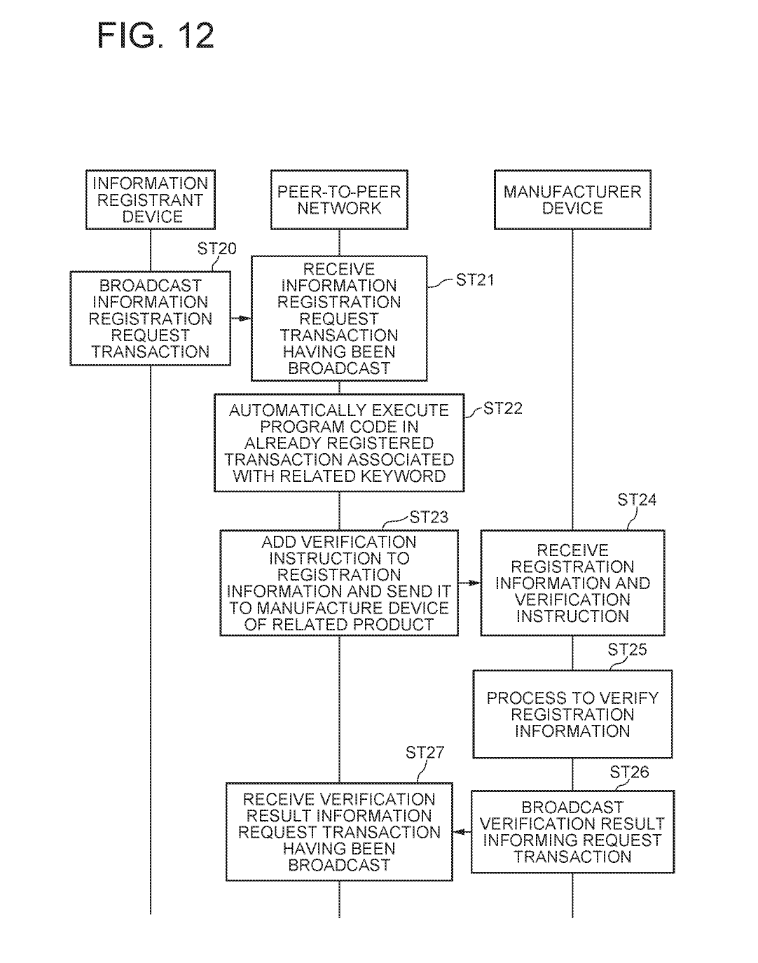

FIG. 12 is a flowchart showing another example of processing by the node 40 participating in the peer-to-peer network 30.

With reference to FIG. 12, when the information registrant device 10 broadcasts the information registration request transaction I20 shown in FIG. 5 to the peer-to-peer network 30 (ST20), the node 40 receives the information registration request transaction I20 having been broadcast (ST21). Next, the node 40 executes the processing shown in FIG. 10, which is omitted in FIG. 12. Upon retaining the received information registration request transaction I20 as a valid transaction into the latest, not-generated block, the node 40 executes the following processing.

The node 40 automatically executes a program code in an already registered transaction associated with a related keyword (ST22). To be specific, the node 40 executes a remote setting program code in the information registration request transaction I720 already registered in the blockchain shown in FIG. 6, whose product keyword list in the profile information includes the same product keyword as the product keyword in the currently received information registration request transaction I20. This is equivalent to that by the program code automatic execution function according to Non-Patent Document 2, the program code in the already registered transaction I720 associated with a related keyword is automatically executed with accumulation of the information registration request transaction I20 into the blockchain as a trigger.

By automatic execution of the program code, the node 40 retrieves the current information registration request transaction I20 from the blockchain, adds an instruction regulated by the program code, that is, information urging the process to validate registration information to the information registration request transaction I20, and sends to a manufacturer device having an address specified by the program code (ST23). Automatic execution of the program code is performed by the node 40 related to a person mining a block including the information registration request transaction I20.

Upon receiving registration information and a validity verification instruction (ST24), the manufacturer device executes a process to verify the validity of the registration information (ST25). This process is executed, for example, in the following manner. First, the manufacturer device notifies a person in charge who executes the verification process by, for example, displaying the received registration information on a display device. Next, the person in charge checks a relevant product to know whether the registration information is valid as necessary and tests to confirm. Then, based on the result of checking and the result of testing, the person in charge generates a verification result and inputs the result into the manufacturer device. When the result of verification of the validity of the registration information is input, the manufacturer device generates a verification result informing request transaction, and broadcasts the transaction to the peer-to-peer network 30 (ST26). The verification result informing request transaction has a similar content to that of the information registration request transaction shown in FIG. 6, for example. However, the result of verification of the validity of the registration information is used instead of the profile information.

Upon receiving the verification result informing request transaction having been broadcast (ST27), the node 40 executes the processing shown in FIG. 10, which is omitted in FIG. 12. Consequently, the node 40 retains the received informing request transaction as a valid transaction into the latest, not-generated block.

### Effect of This Example Embodiment

According to this example embodiment, an information registration request transaction including an invalid electronic signature will not be accumulated in a blockchain that is a bulletin board information management DB. Therefore, it is possible to prevent a malicious third party who impersonates someone else or rewrites registration information of someone else from posting information on a bulletin board.

Further, a bulletin board information management DB is managed by all the nodes 40 participating in the peer-to-peer network 30. Therefore, it is possible to prevent the malicious node 40 from rewriting or tampering with the registration information. Moreover, it is possible to provide a bulletin board information management DB which is excellent in reliability, availability and maintainability.

### Third Example Embodiment

In this example embodiment, the outline of the present invention will be described.

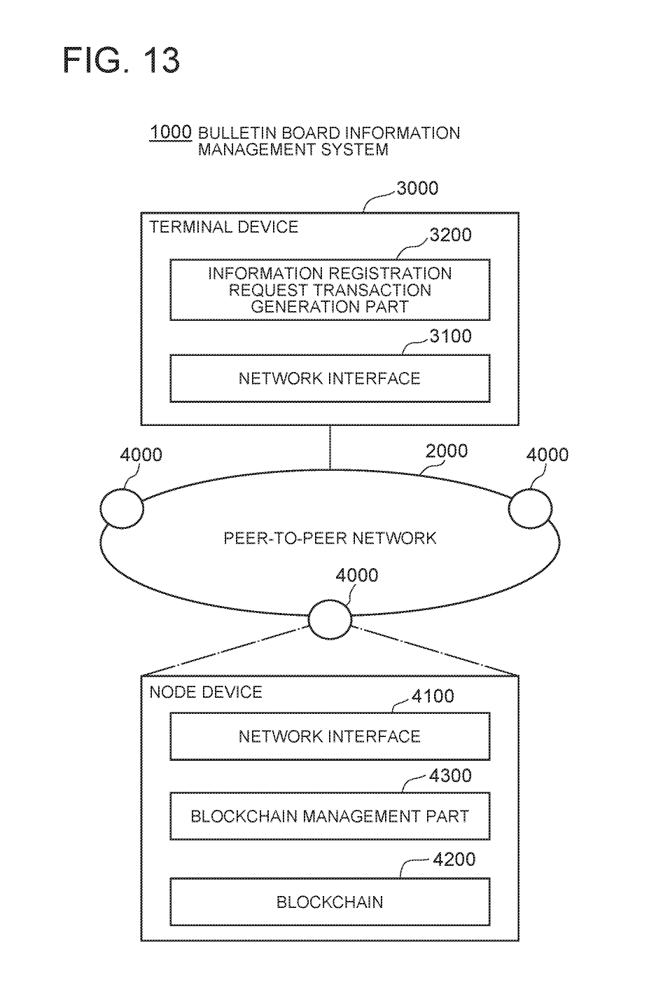

With reference to FIG. 13, a bulletin board information management system 1000 according to this example embodiment includes a peer-to-peer network 2000 including a plurality of node devices 4000 capable of peer-to-peer communication with each other, and a terminal device 3000.

The terminal device 3000 includes a network interface 3100 and an information registration request transaction generation part 3200. The information registration request transaction generation part 3200 has a function to generate an information registration request transaction and broadcast the transaction to the peer-to-peer network 2000 through the network interface 3100. To be specific, the information registration request transaction generation part 3200 is configured to generate the information registration request transaction based on: first information including a keyword on a product and bulletin board information representing a customer's opinion on the product; an electronic signature signed on the first information by using the customer's private key; and a public key paired with the private key. The information registration request transaction generation part 3200 can be configured in the same manner as the information registration request transaction generation part described in the first and second example embodiments, but is not limited to.

Each of the node devices 4000 includes a network interface 4100, a blockchain 4200, and a blockchain management part 4300. The blockchain 4200 is a data structure formed by connecting blocks each grouping transactions over a certain period, in a chain. For example, the blockchain 4200 may be a blockchain of Ethereum, but is not limited thereto. The blockchain 4200 is also referred to as a bulletin board information DB. The blockchain management part 4300 has a function to accumulate information registration request transactions received via the network interface 4100 into the blockchain 4200 based on a consensus building algorithm executed in cooperation with the other node device 4000. The blockchain management part 4300 can be configured similarly to the blockchain management part described in the first and second embodiments, but is not limited thereto.

The bulletin board information management system 1000 according to this example embodiment configured as described above operates as follows. In other words, the terminal device 3000 generates the information registration request transaction, by the information registration request transaction generation part 3200, based on first information including a keyword on a product and bulletin board information representing an opinion of a customer on the product, an electronic signature signed on the first information with the private key of the customer, and a public key paired with the private key. Next, the terminal device 3000 broadcasts the information registration request transaction to the peer-to-peer network 2000 via the network interface 3100.

Each of the node devices 4000 receives the broadcast information registration request transaction through the network interface 4100. Next, each of the node devices 4000 accumulates the received information registration request transaction into the blockchain 4200 based on a consensus building algorithm executed in cooperation with another node device 4000 by the blockchain management unit 4300.

As described above, according to this example embodiment, bulletin board information is managed by the blockchain technology, so that a bulletin board information management system with excellent reliability, availability and maintainability can be provided. That is, the bulletin board information management system according to this example embodiment has higher reliability and is excellent in availability and so on when compared with the existing bulletin board information management system. Moreover, the bulletin board information management system according to this example embodiment is excellent in confidentiality because it is difficult to invade or tamper from outside. As described above, the bulletin board information management system according to this example embodiment exerts more technical effects than the existing bulletin board information management system.

Although the present invention has been described above by using the example embodiments, the present invention is not limited to the example embodiments. The configurations and details of the present invention can be changed and modified in various manners that can be understood by one skilled in the art within the scope of the present invention.

The present invention is based upon and claims the benefit of priority from Japanese patent application No. 2016-148246, filed on Jul. 28, 2016, the disclosure of which is incorporated herein in its entirety by reference.

The present invention can be used in the field of managing bulletin board information, for example, a public bulletin board such as a user group portal, devotee's SNS and Twitter™ related to a product.

The whole or part of the example embodiments disclosed above can be described as, but not limited to, the following supplementary notes.

### Supplementary Note 1

A node device configuring a peer-to-peer network, the node device comprising:

a network interface; and

a blockchain management part configured to: receive, through the network interface, a first information registration request transaction that includes first information including a keyword on a product and bulletin board information representing an opinion of a customer on the product, an electronic signature signed on the first information with a private key of the customer, and a public key paired with the private key; and accumulate the first information registration request transaction into a blockchain based on a consensus building algorithm executed in cooperation with another node device configuring the peer-to-peer network.

### Supplementary Note 2

The node device according to Supplementary Note 1, wherein the blockchain management part is configured to: receive, through the network interface, a second information registration request transaction that includes second information including a list of the keyword on the product, a program code and a certificate of a manufacturer, an electronic signature signed on the second information with a private key of the manufacturer, and a public key paired with the private key of the manufacturer; and accumulate the second information registration request transaction into the blockchain based on the consensus building algorithm.

### Supplementary Note 3

The node device according to Supplementary Note 2, wherein the program code is configured to, upon executed by a computer configuring the blockchain management part, in a case where the keyword on the product included in the first information registration request transaction accumulated in the blockchain is written in the list of the keyword, cause the computer to send the bulletin board information included in the first information registration request transaction to a terminal device corresponding to the manufacturer.

### Supplementary Note 4

The node device according to Supplementary Note 3, wherein the program code is further configured to cause the computer to send information urging a process of verification of validity of the bulletin board information to the terminal device corresponding to the manufacturer.

### Supplementary Note 5

The node device according to Supplementary Note 4, wherein the blockchain management part is configured to: receive, through the network interface, a third information registration request transaction that includes third information including a result of the verification of the validity of the bulletin board information and the certificate of the manufacturer, an electronic signature signed on the third information with the private key of the manufacturer, and the public key paired with the private key of the manufacturer; and accumulate the third information registration request transaction into the blockchain based on the consensus building algorithm.

### Supplementary Note 6

The node device according to any of Supplementary Notes 2 to 5, wherein the program code is configured to be automatically executed at a moment when the first information registration request transaction is accumulated into the blockchain.

### Supplementary Note 7

The node device according to any of Supplementary Notes 1 to 6, wherein the blockchain management part is configured to: retrieve, from the blockchain, another first information registration request transaction that includes a same keyword as the keyword on the product included in the first information registration request transaction having been received; and judge validity of the first information registration request transaction having been received, based on a result of comparison between the public key included in the other first information registration request transaction having been retrieved and the public key included in the first information registration request transaction having been received.

### Supplementary Note 8

The node device according to Supplementary Note 7, wherein the blockchain management part is configured to judge the first information registration request transaction having been received is valid if the public key included in the first information registration request transaction having been received matches the public keys included in all the other first information registration request transactions having been retrieved.

### Supplementary Note 9

The node device according to any of Supplementary Notes 1 to 8, further comprising a query response part configured to, upon receiving a query request through the network interface, acquire bulletin board information corresponding to a keyword on a product included in the query request from the information accumulated in the blockchain, and generate a response for sending through the network interface.

### Supplementary Note 10

A bulletin board information management method executed by a node device including a network interface and a blockchain management part and configuring a peer-to-peer network,

wherein the blockchain management part is configured to: receive, through the network interface, a first information registration request transaction that includes first information including a keyword on a product and bulletin board information representing an opinion of a customer on the product, an electronic signature signed on the first information with a private key of the customer, and a public key paired with the private key; and accumulate the first information registration request transaction into a blockchain based on a consensus building algorithm executed in cooperation with another node device configuring the peer-to-peer network.

### Supplementary Note 11

A computer program comprising instructions for causing a computer configuring a peer-to-peer network to function as:

a network interface; and

a blockchain management part configured to: receive, through the network interface, a first information registration request transaction that includes first information including a keyword on a product and bulletin board information representing an opinion of a customer on the product, an electronic signature signed on the first information with a private key of the customer, and a public key paired with the private key; and accumulate the first information registration request transaction into a blockchain based on a consensus building algorithm executed in cooperation with another node device configuring the peer-to-peer network.

### Supplementary Note 12

A terminal device broadcasting an information registration request transaction to a peer-to-peer network configured by a plurality of node devices capable of peer-to-peer communication with each other, the terminal device comprising:

a network interface; and

an information registration request transaction generation part configured to generate the information registration request transaction and broadcast to the peer-to-peer network through the network interface,

wherein the information registration request transaction generation part is configured to: generate the information registration request transaction based on first information including a keyword on a product and bulletin board information representing an opinion of a customer on the product, an electronic signature signed on the first information with a private key of the customer, and a public key paired with the private key.

### Supplementary Note 13

A bulletin board information management system including a peer-to-peer network configured by a plurality of node devices capable of peer-to-peer communication with each other and a terminal device,

wherein the terminal device includes:

a first network interface; and

an information registration request transaction generation part configured to generate a first information registration request transaction and broadcast to the peer-to-peer network through the first network interface,

wherein the information registration request transaction generation part is configured to generate the first information registration request transaction based on first information including a keyword on a product and bulletin board information representing an opinion of a customer on the product, an electronic signature signed on the first information with a private key of the customer, and a public key paired with the private key, and

wherein each of the node devices includes:

a second network interface; and

a blockchain management part configured to accumulate the first information registration request transaction received through the second network interface into a blockchain based on a consensus building algorithm executed in cooperation with another node device.

### DESCRIPTION OF NUMERALS

1 bulletin board information management system

2 peer-to-peer network

2a node device

2b network interface

2c arithmetic processing part

2d storage part

2e program

2f blockchain

2g blockchain management part

2h query response part

3 information registrant device

3a network interface

3b arithmetic processing part

3c storage part

3d program

3e information registration request transaction generation part

4 information user device

4a network interface

4b arithmetic processing part

4c storage part

4d program

4e information use request transaction generation part

10 information registrant device

20 information user device

30 peer-to-peer network

40 participating node

I10 information registrant device retention information

I20 information registration request transaction

I710 product manufacturer validity confirmation profile information

I720 information registration request transaction

1000 bulletin board information management system

2000 peer-to-peer network

3000 information registrant device

3100 network interface

3200 information registration request transaction generation part

4000 node device

4100 network interface

4200 blockchain

4300 blockchain management part

1. A node device configuring a peer-to-peer network, the node device comprising:
a network interface;
a memory including a program instruction; and
a processor connected to the network interface and the memory,
wherein the processor is programmed to execute the program instruction to: receive, through the network interface, a first information registration request transaction that includes first information including a keyword on a product and bulletin board information representing an opinion of a customer on the product, an electronic signature signed on the first information with a private key of the customer, and a public key paired with the private key; and accumulate the first information registration request transaction into a blockchain based on a consensus building algorithm executed in cooperation with another node device configuring the peer-to-peer network.

2. The node device according to claim 1, wherein the processor is further programmed to: receive, through the network interface, a second information registration request transaction that includes second information including a list of the keyword on the product, a program code and a certificate of a manufacturer, an electronic signature signed on the second information with a private key of the manufacturer, and a public key paired with the private key of the manufacturer; and accumulate the second information registration request transaction into the blockchain based on the consensus building algorithm.

3. The node device according to claim 2, wherein the program code is configured to, upon executed by the processor, in a case where the keyword on the product included in the first information registration request transaction accumulated in the blockchain is written in the list of the keyword, cause the processor to send the bulletin board information included in the first information registration request transaction to a terminal device corresponding to the manufacturer.

4. The node device according to claim 3, wherein the program code is further configured to cause the processor to send information urging a process of verification of validity of the bulletin board information to the terminal device corresponding to the manufacturer.

5. The node device according to claim 4, wherein the processor is further programmed to: receive, through the network interface, a third information registration request transaction that includes third information including a result of the verification of the validity of the bulletin board information and the certificate of the manufacturer, an electronic signature signed on the third information with the private key of the manufacturer, and the public key paired with the private key of the manufacturer; and accumulate the third information registration request transaction into the blockchain based on the consensus building algorithm.

6. The node device according to claim 2 wherein the program code is configured to be automatically executed at a moment when the first information registration request transaction is accumulated into the blockchain.

7. The node device according to claim 1, wherein the processor is further programmed to: retrieve, from the blockchain, another first information registration request transaction that includes a same keyword as the keyword on the product included in the first information registration request transaction having been received; and judge validity of the first information registration request transaction having been received, based on a result of comparison between the public key included in the other first information registration request transaction having been retrieved and the public key included in the first information registration request transaction having been received.

8. The node device according to claim 7, wherein the processor is programmed to judge the first information registration request transaction having been received is valid if the public key included in the first information registration request transaction having been received matches the public keys included in all the other first information registration request transactions having been retrieved.

9. The node device according to claim 1, wherein the processor is further programmed to, upon receiving a query request through the network interface, acquire bulletin board information corresponding to a keyword on a product included in the query request from the information accumulated in the blockchain, and generate a response for sending through the network interface.

10. A bulletin board information management method executed by a node device configuring a peer-to-peer network, the bulletin board information management method comprising:
receiving a first information registration request transaction that includes first information including a keyword on a product and bulletin board information representing an opinion of a customer on the product, an electronic signature signed on the first information with a private key of the customer, and a public key paired with the private key; and
accumulating the first information registration request transaction into a blockchain based on a consensus building algorithm executed in cooperation with another node device configuring the peer-to-peer network.

11. A non-transitory computer-readable medium storing a computer program comprising instructions for causing a computer configuring a peer-to-peer network to execute a process to:
receive, through the network interface, a first information registration request transaction that includes first information including a keyword on a product and bulletin board information representing an opinion of a customer on the product, an electronic signature signed on the first information with a private key of the customer, and a public key paired with the private key; and accumulate the first information registration request transaction into a blockchain based on a consensus building algorithm executed in cooperation with another node device configuring the peer-to-peer network.

12-13. (canceled)
